(19) United States
(12) Patent Application Publication
(10) Pub. No.: US 2014/0280073 A1
(43) Pub. Date: Sep. 18, 2014

(54) METHOD AND SYSTEM FOR EVENT BASED ANALYSIS

(71) Applicant: FUTRIXIP LIMITED, Wellington (NZ)

(72) Inventors: Ian James Sutton, Wellington (NZ); Syuzanna Vartkesovna Zakharova, Macedonia, OH (US)

(73) Assignee: FUTRIXIP LIMITED, Wellington (NZ)

(21) Appl. No.: 14/212,201

(22) Filed: Mar. 14, 2014

Related U.S. Application Data
(60) Provisional application No. 61/799,209, filed on Mar. 15, 2013.

(51) Int. Cl. G06F 17/30

(52) U.S. Cl. CPC G06F 17/30424
USPC 707/722

(57) ABSTRACT

System, method and computer readable media embodiments are disclosed for performing event based analysis where a first query is performed on a first data source to obtain a first set of records based on a first event and a second query (independent from the first query) is performed on a second data source to obtain a second set of records based on a second event. Each set of records includes analysis dimension variable and a time dimension. A result set is generated by combining the first and second sets of records to find an intersection of the two sets based at least partly on the time dimension variables. A binary mapping is generated from the result set to establish a distinct set of values of the analysis dimension variable that match the intersection of the two sets.

### CROSS-REFERENCE TO RELATED APPLICATIONS

This application claims the benefit of U.S. Provisional Application No. 61/799,209, filed Mar. 15, 2013, which is hereby incorporated by reference in its entirety.

### FIELD OF INVENTION

The invention relates to a method and system for event based analysis.

### BACKGROUND

It is often necessary to answer specific analytic questions that involve a sub-set of the data meeting a certain criteria, where the criteria is defined by a series of specific events (criteria based on set of filters) occurring within a specified time frame between events.

It is difficult to identify segments of a population meeting certain criteria and then use these segments to answer further questions and for analysis. The following are some examples of typical business questions that require answers:
HealthCare: How does utilization of Professional and Pharmacy services compare for patients who end up admitted into Inpatient Facility within 30 days of receiving Emergency Room services vs. those who do not.
HealthCare: How many patients are taking a particular Drug one year after a Heart surgery and how their medical costs compare to those who do not take the drug.
Banking: Identify a set of people who have opened a Mortgage with the bank in the last year and have applied for a Credit Card within 90 days after the Mortgage and compare their borrowing risk factors to those who do not apply for a Credit Card so soon.

The mechanism to do this type of analysis needs to be able to work for data of any nature, any industry, any division within a company, any volume of data, and on any entity Dimension even if it has very high cardinality (for example Customer ID, Individual ID, or even Transaction ID).

The data source that the events are defined with may not be the data source that it is desired to use the derived population with. For example in a HealthCare domain it may be important to analyze Patients who had an Inpatient Admission within 30 days of Emergency Room services. It is necessary to define one of the events based on the Outpatient data source, to identify everybody who had Emergency Room services, and then to define the other event (Inpatient Admission) based on the Inpatient data source. Then the population identified by the 2 events and time based relationship between them for each Patient can be used on any other data source, including Enrolment data, Pharmacy, etc.

One solution for generation of attribute driven temporal clustering is described in WO 2010/148326 to Ingenix, Inc. (Ingenix) involving searching across separate databases of healthcare claim data, lab data, physical test data and so on. A query collects a consolidated set of data elements associated with an individual or group of individuals. A consolidated data set is stored in a consolidated data storage device.

One drawback of Ingenix is that the queries envisaged appear to be related to each other, in that one query is performed on the data set obtained from an earlier query.

Even though the “complete analysis” may come from two or multiple independent data sources, it should not be a requirement that these data sources are merged at any point or at any aggregation level. These data sources could be massive and therefore any performance or storage requirements for the merge of them should be avoided.

It is an object of preferred embodiments of the present invention to address at least some of the aforementioned issues. An additional and/or alternative object is to at least provide the public with a useful choice.

### SUMMARY OF THE INVENTION

In one aspect the invention provides a method of performing event based analysis comprising performing a first query on a first data source to obtain a first set of records based on a first event, the first set of records including an analysis dimension variable and a first time dimension variable; performing a second query on a second data source, the second query independent from the first query, to obtain a second set of records based on a second event, the second set of records including the analysis dimension variable and a second time dimension variable; generating a result set by combining the first set of records and the second set of records to find an intersection of the two sets based at least partly on the first time dimension variable and the second time dimension variable; and generating a binary mapping from the result set to establish a distinct set of values of the analysis dimension variable that match the intersection of the two sets.

The term ‘comprising’ as used in this specification and claims means ‘consisting at least in part of’. When interpreting statements in this specification and claims which include the term ‘comprising’, other features besides the features prefaced by this term in each statement can also be present. Related terms such as ‘comprise’ and ‘comprised’ are to be interpreted in similar manner.

Preferably performing the first query on the first data source includes applying a detail level filter.

Preferably the detail level filter is based at least partly on a stored binary mapping.

Preferably performing the second query on the second data source includes applying a detail level filter.

Preferably the detail level filter is based at least partly on a stored binary mapping.

Preferably the method further comprises performing an aggregation of the first set of records.

Preferably the method further comprises applying a post-aggregation filter to the first set of records.

Preferably the post-aggregation filter is based at least partly on a stored binary mapping.

Preferably the method further comprises performing an aggregation of the second set of records.

Preferably the method further comprises applying a post-aggregation filter to the second set of records.

Preferably the post-aggregation filter is based at least partly on a stored binary mapping.

Preferably the method further comprises receiving a time interval, the values of the first time dimension variable and the second time dimension variable in the intersection of the two sets lying within the time interval.

Preferably the method further comprises receiving a time interval, the values of the first time dimension variable and the second time dimension variable in the intersection of the two sets lying outside the time interval.

Preferably the method further comprises receiving a time interval, the values of the first time dimension variable and the second time dimension variable in the intersection of the two sets equal to the time interval.

Preferably the analysis dimension variable uniquely identifies the first set of records.

Preferably the analysis dimension variable uniquely identifies the second set of records.

Preferably the first data source is independent of the second data source.

Preferably the first data source is related to the second data source.

Preferably the method further comprises performing a third query on a third data source based at least partly on the binary mapping.

Preferably the method further comprises displaying a representation of the binary mapping on a user device.

In another aspect the invention comprises a system for event based analysis, comprising at least one processor programmed to perform a first query on a first data source to obtain a first set of records based on a first event, the first set of records including an analysis dimension variable and a first time dimension variable; perform a second query on a second data source, the second query independent from the first query, to obtain a second set of records based on a second event, the second set of records including the analysis dimension variable and a second time dimension variable; generate a result set by combining the first set of records and the second set of records to find an intersection of the two sets based at least partly on the first time dimension variable and the second time dimension variable; and generate a binary mapping from the result set to establish a distinct set of values of the analysis dimension variable that match the intersection of the two sets.

Preferably performing the first query on the first data source includes applying a detail level filter.

Preferably the detail level filter is based at least partly on a stored binary mapping.

Preferably performing the second query on the second data source includes applying a detail level filter.

Preferably the detail level filter is based at least partly on a stored binary mapping.

Preferably the at least one processor is further programmed to perform an aggregation of the first set of records.

Preferably the at least one processor is further programmed to apply a post-aggregation filter to the first set of records.

Preferably the post-aggregation filter is based at least partly on a stored binary mapping.

Preferably the at least one processor is further programmed to perform an aggregation of the second set of records.

Preferably the at least one processor is further programmed to apply a post-aggregation filter to the second set of records.

Preferably the post-aggregation filter is based at least partly on a stored binary mapping.

Preferably the at least one processor is further programmed to receive a time interval, the values of the first time dimension variable and the second time dimension variable in the intersection of the two sets lying within the time interval.

Preferably the at least one processor is further programmed to receive a time interval, the values of the first time dimension variable and the second time dimension variable in the intersection of the two sets lying outside the time interval.

Preferably the at least one processor is further programmed to receive a time interval, the values of the first time dimension variable and the second time dimension variable in the intersection of the two sets equal to the time interval.

Preferably the analysis dimension variable uniquely identifies the first set of records.

Preferably the analysis dimension variable uniquely identifies the second set of records.

Preferably the first data source is independent of the second data source.

Preferably the first data source is related to the second data source.

Preferably the at least one processor is further programmed to perform a third query on a third data source based at least partly on the binary mapping.

Preferably the system is further configured to display a representation of the binary mapping on a user device.

In a further aspect the invention comprises a system for event based analysis comprising a user interface layer configured to receive a first query and a second query; a data management layer configured to receive a direction from the user interface layer based at least partly on the first query and the second query; a query engine configured to perform the first query on a first data source and to perform a second query on a second data source; and a data storage component configured to store a first set of records obtained from performing the first query on the first data source, the first set of records including an analysis dimension variable and a first time dimension variable; a second set of records obtained from performing the second query on the second data source, the second set of records including the analysis dimension variable and a second time dimension variable; a result set obtained by the data management layer combining the first set of records and the second set of records to find an intersection of the two sets based at least partly on the first time dimension variable and the second time dimension variable; and a binary mapping generated by the data management layer at least partly from the result set.

In another aspect the invention comprises a computer-readable medium having stored thereon processor-executable instructions that when executed by a processor cause the processor to perform a method of performing event based analysis, the method comprising performing a first query on a first data source to obtain a first set of records based on a first event, the first set of records including an analysis dimension variable and a first time dimension variable; performing a second query on a second data source, the second query independent from the first query, to obtain a second set of records based on a second event, the second set of records including the analysis dimension variable and a second time dimension variable; generating a result set by combining the first set of records and the second set of records to find an intersection of the two sets based at least partly on the first time dimension variable and the second time dimension variable; and generating a binary mapping from the result set to establish a distinct set of values of the analysis dimension variable that match the intersection of the two sets.

Preferably performing the first query on the first data source includes applying a detail level filter.

Preferably the detail level filter is based at least partly on a stored binary mapping.

Preferably performing the second query on the second data source includes applying a detail level filter.

Preferably the detail level filter is based at least partly on a stored binary mapping.

Preferably the method further comprises performing an aggregation of the first set of records.

Preferably the method further comprises applying a post-aggregation filter to the first set of records.

Preferably the post-aggregation filter is based at least partly on a stored binary mapping.

Preferably the method further comprises performing an aggregation of the second set of records.

Preferably the method further comprises applying a post-aggregation filter to the second set of records.

Preferably the post-aggregation filter is based at least partly on a stored binary mapping.

Preferably the method further comprises receiving a time interval, the values of the first time dimension variable and the second time dimension variable in the intersection of the two sets lying within the time interval.

Preferably the method further comprises receiving a time interval, the values of the first time dimension variable and the second time dimension variable in the intersection of the two sets lying outside the time interval.

Preferably the method further comprises receiving a time interval, the values of the first time dimension variable and the second time dimension variable in the intersection of the two sets equal to the time interval.

Preferably the analysis dimension variable uniquely identifies the first set of records.

Preferably the analysis dimension variable uniquely identifies the second set of records.

Preferably the first data source is independent of the second data source.

Preferably the first data source is related to the second data source.

Preferably the method further comprises performing a third query on a third data source based at least partly on the binary mapping.

Preferably the method further comprises displaying a representation of the binary mapping on a user device.

As used herein the term “dimension” means:
a variable/column in the data (numeric or character) that is used for data classification and/or filtering (e.g. Product ID, Region, Item Description). It is used from a “group by” categorical perspective and will have a set of distinct values; or
a “virtual variable/column” that is created by this process, i.e. the Event Based Analysis Group that is created is a “dimension” that is available to end users for analysis (classification or filtering), but does not actually exist in the original data source, instead it is dynamically derived on the fly. i.e. it doesn't physically exist in the database, however to the end user performing queries or producing tables and charts from the data, this Virtual Dimension appears and works as if it does exist, not just in the data source they first define it from but a variety of other data sources as well.

As used herein the term “query” means “query and summarization” performed in a single step. All of the queries described herein assume summarization of the data source to some aggregated summary level, rather than just a query of the detail data.

The invention in one aspect comprises several steps. The relation of one or more of such steps with respect to each of the others, the apparatus embodying features of construction, and combinations of elements and arrangement of parts that are adapted to affect such steps, are all exemplified in the following detailed disclosure.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

In addition, where features or aspects of the invention are described in terms of Markush groups, those persons skilled in the art will appreciate that the invention is also thereby described in terms of any individual member or subgroup of members of the Markush group. As used herein, ‘(s)’ following a noun means the plural and/or singular forms of the noun. As used herein, the term ‘and/or’ means ‘and’ or ‘or’ or both.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9, and 10) and also any range of rational numbers within that range (for example, 2 to 8, 1.5 to 5.5, and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

As used herein the term “Yes” and “No” as used in this specification and claims means the two binary values resulting from the binary mapping, which could also be interchangeably represented by any other two different values such as “In” and “Out”, or “True” and “False”, “1” and “0”, etc.

The term “computer-readable medium” should be taken to include a single medium or multiple media. Examples of multiple media include a centralised or distributed database and/or associated caches. These multiple media store the one or more sets of computer executable instructions. The term “computer readable medium” should also be taken to include any medium that is capable of storing, encoding or carrying a set of instructions for execution by a processor and that cause the processor to perform any one or more of the methods described above. The computer-readable medium is also capable of storing, encoding or carrying data structures used by or associated with these sets of instructions. The term “computer-readable medium” includes solid-state memories, optical media and magnetic media.

The term “connected to” includes all direct or indirect types of communication, including wired and wireless, via a cellular network, via a data bus, or any other computer structure. It is envisaged that they may be intervening elements between the connected integers. Variants such as “in communication with”, “joined to”, and “attached to” are to be interpreted in a similar manner.

In this specification where reference has been made to patent specifications, other external documents, or other sources of information, this is generally for the purpose of providing a context for discussing the features of the invention. Unless specifically stated otherwise, reference to such external documents or such sources of information is not to be construed as an admission that such documents or such sources of information, in any jurisdiction, are prior art or form part of the common general knowledge in the art.

Although the present invention is broadly as defined above, those persons skilled in the art will appreciate that the invention is not limited thereto and that the invention also includes embodiments of which the following description gives examples.

### BRIEF DESCRIPTION OF FIGURES

Preferred forms of a method and system for event based analysis are described with reference to the accompanying figures by way of example and without intending to be limiting, wherein:

FIG. 1 shows a preferred form system in which the invention is intended to operate.

FIG. 2 shows a preferred form computing device from FIG. 1.

FIG. 3 shows a preferred form process for event based analysis.

FIG. 4 shows a further preferred form process applying one or more detail level filters.

FIG. 5 shows a further preferred form process applying one or more post-aggregation filters.

FIG. 6 shows a preferred form start screen for creating a new Event Based Analysis Dimension.

FIG. 7 shows an example of creating a new Event Based Analysis Dimension.

FIG. 8 shows an example of saving a newly created Event Based Analysis Dimension.

FIG. 9 shows a preferred form pull-down menu for applying Event Based Analysis dimensions.

FIG. 10 shows a user applying an Event Based Analysis Dimension.

FIG. 11 shows a preferred form screen showing creation of a new Virtual Dimension.

FIG. 12 shows a preferred form process for modifying the definition of an Event Based Analysis Dimension.

FIG. 13 shows preferred form operations available to a user.

FIG. 14 shows preferred form editing or duplicating the Event Based Analysis Dimension.

### DETAILED DESCRIPTION

FIG. 1 shows a preferred form system 100 in which the invention is intended to operate. The system includes a plurality of data sources indicated at 105_{1 . . . N}. The data in data sources 105_{1 . . . N} is stored on one or more data storage devices. One or more query engines 110 is/are adapted to perform queries on one or more of the data sources 105.

The system 100 further includes a data management and processing layer 115. The data management layer is connected to or interfaced to the query engine(s) 110. In one form query engine(s) 110 comprise(s) computer executable instructions installed on a computing device. It is configured to delegate responsibility to one or more of the query engines to obtain data from data sources 105. Result sets obtained by the data management layer 115 are preferably stored in a data storage component 120.

A user interface layer 125 is preferably in communication with the data management layer 115 and data storage 120. The user interface is configured to present output to a user and receive user input that is then delegated to the data management layer 115.

The system also includes a plurality of user devices 130_{1 . . . N}. It is envisaged that there are many different forms of user device 130 and user interface layer 125. Examples include a desktop (thick client), a web interface, a flash application, a mobile device, and a batch processing device using a scripted approach. The user devices 130 in one form have a version of the user interface layer 125 and the data management layer 115 installed in the form of computer executable instructions on servers connected to the user devices 130.

Preferably the data storage 120 provides temporary and/or caching data storage to the data management layer 115, the query engine(s) 110 and/or the user interface 125.

FIG. 2 shows a simplified block diagram of a device forming at least part of data storage component 120, user devices 130, and data storage devices on which are stored data sources 105 in the example form of a computing device 200.

Sets of computer executable instructions are executed within device 200 that cause the device 200 to perform the methods described below. Preferably the computing device 200 is connected to other devices. Where the device is networked to other devices, the device is configured to operate in the capacity of a server or a client machine in a server-client network environment. Alternatively the device can operate as a peer machine in a peer-to-peer or distributed network environment. The device may also include any other machine capable of executing a set of instructions that specify actions to be taken by that machine. These instructions can be sequential or otherwise.

A single device 200 is shown in FIG. 2. The term “computing device” also includes any collection of machines that individually or jointly execute a set or multiple sets of instructions to perform any one or more of the methods described above.

The example computing device 200 includes a processor 205. One example of a processor is a central processing unit or CPU. The device further includes read-only memory (ROM) 210 and random access memory (RAM) 215. Also included is a Basic Input/Output System (BIOS) chip 220. The processor 205, ROM 210, RAM 215 and the BIOS chip 220 communicate with each other via a central motherboard 225.

Computing device 200 further includes a power supply 230 which provides electricity to the computing device 200. Power supply 230 may also be supplemented with a rechargeable battery (not shown) that provides power to the device 200 in the absence of external power.

Also included are one or more drives 235. These drives include one or more hard drives and/or one or more solid state flash hard drives. Drives 235 also include optical drives.

Network interface device 240 includes a modem and/or wireless card that permits the computing device 200 to communicate with other devices. Computing device 200 may also comprise a sound and/or graphics card 245 to support the operation of the data output device 260 described below. Computing device 200 further includes a cooling system 250 for example a heat sink or fan.

Computing device 200 includes one or more data input devices 255. These devices include a keyboard, touchpad, touchscreen, mouse, and/or joystick. The device(s) take(s) input from manual key presses, user touch with finger(s) or stylus, spoken commands, gestures, and/or movement/orientation of the device.

Data output device(s) 260 include(s) a display and/or printer. Device(s) 260 may further include computer executable instructions that cause the computing device 200 to generate a data file such as a PDF file.

Data port 265 is able to receive a computer readable medium on which is stored one or more sets of instructions and data structures, for example computer software. The software causes the computing device 200 to perform one or more of the methods or functions described above. Data port 265 includes a USB port, Firewire port, or other type of interface. The computer readable medium includes a solid state storage device. Where drives 235 include an optical media drive, the computer readable medium includes a CD-ROM, DVD-ROM, Blu-ray, or other optical medium.

Software may also reside completely or at least partially within ROM 210, within erasable non-volatile storage and/or within processor 205 during execution by the computing device 200. In this case ROM 210 and processor 205 constitute computer-readable tangible storage media. Software may further be transmitted or received over a network via network interface device 240. The data transfer uses any one of a number of well known transfer protocols. One example is hypertext transfer protocol (http).

FIG. 3 shows a preferred form process 300 for performing event based analysis in accordance with one aspect of the invention. As shown in FIG. 3 the preferred form method involves performing 305 a first query on a first data source. Preferably user device 130 and user interface layer 125 issue a direction to data management layer 115. The data management layer 115 then delegates a query to a query engine 110 to query data source 105₁.

The result of the query is a first set of records 310 based on a first event. The first set of records is preferably stored in data storage 120. The first set of records includes an analysis dimension variable and a first time dimension variable. Examples of analysis dimension variables and time dimension variables are provided below.

A second query is performed 315 on a second data source for example data source 105₂. The second query is independent from the first query. A traditional query execution involves obtaining a first set of records based on a first query and then performing a second query on the results of the first query, in which case the first query and the second query are not independent.

In the case of the invention the first query is independent from the second query as the second query is not performed on the results of the first query.

The second query obtains 320 a second set of records that is based on a second event. The second set of records is preferably also stored in the data storage 120. The second set of records includes the same analysis dimension variable or an equivalent analysis dimension variable as the first set of records. The second set of records further includes a second time dimension variable.

It will be appreciated that the first data source and the second data source in one form are distinct unrelated data sources. In this case the first and second queries would involve data source 105₁ and data source 105₂ respectively.

Alternatively the first data source and the second data source comprise the same data source 105₁. The first query and the second query are still independent as they are not performed on the results of one another. The first query and the second query are performed independently on the same data source 105₁.

The data management layer 115 generates a result set by combining 325 the first set of records and the second set of records. The result set is an intersection of the first set of records and the second set of records. The intersection is based at least partly on the first time dimension variable and the second time dimension variable. Examples of intersections of sets are described below.

The data management layer 115 generates 330 a binary mapping from the results set preferably stored in data storage 120. The result of the binary mapping is preferably a distinct set of values of the analysis dimension variable that match the intersection of the two sets.

The binary mapping is then presented to the user through the user interface layer 125 and/or used as a filter for subsequent queries to one or more of the data sources 105 and/or used to cluster values of the Analysis Dimension together in subsequent queries to one or more of the data sources 105 to then enable comparison between the two parts of the binary mapping.

The following metadata is required in order to create and use an Event Based Analysis Dimension:
Name
First Event:
   Data Source 1
   Analysis Dimension
   Time Dimension 1
   Optional: Detail Level Filters 1
   Optional: Post-Aggregation Filters 1
Second Event:
   Data Source 2
   Time Dimension 2
   Optional: Detail Level Filters 2
   Optional: Post-Aggregation Filters 2
Time Interval
Operator

### Create Binary Mapping

The first step in the processing of an analysis that uses the Event Based Analysis Dimension is to create the binary mapping from the distinct ID values of the Analysis Dimension to “Yes” values, implicitly assuming all other values correspond to the opposite binary value of “No”. The following are the required steps to create the binary mapping:
1. Query: Summarize Data Source 1 to Analysis Dimension and Time Dimension 1 values
2. Query: Summarize Data Source 2 to Analysis Dimension and Time Dimension 2 values
3. Merge the two query results by Analysis Dimension keeping only the distinct values of Analysis Dimension where its values exist in both query results and where for that value of the Analysis Dimension at least one difference between Time Dimension 2 and Time Dimension 1 presented in common time units is within the Time Interval using the Operator specified as part of the Event Based Analysis Dimension
4. Store the resulting set of values of the Analysis Dimension as the binary mapping.

The following example shows patients who had an In-patient (IP) Admission within 30 days of Out-patient (OP) visit:

Name: Patients with IP admits soon after OP

First Event:
Data Source: Out-Patient Claims Data
Analysis Dimension Patient ID
Time Dimension Date of Service

Second Event:
Data Source In-Patient Claims Data
Time Dimension: Date of Admission

Time Interval: 30

Operator: “<=”

The following table shows the result of the query to the Analysis Dimension and Time Dimension for the first event (Out-patient visit):

| Patient ID | Date of Service |
|---|---|
| 1000001 | Jan. 5, 2012 |
| 1000002 | May 7, 2011 |
| 1000003 | Apr. 15, 2010 |
| 1000006 | Mar. 3, 2012 |
| 1000007 | Oct. 5, 2012 |

The following table shows the result of the query to the Analysis Dimension and Time Dimension for the second event (In-patient admission):

| Patient ID | Date of Admission |
|---|---|
| 1000001 | Jan. 23, 2012 |
| 1000002 | Mar. 5, 2012 |
| 1000003 | May 7, 2010 |
| 1000004 | Aug. 15, 2011 |
| 1000005 | Sep. 17, 2012 |

The following table shows the result of the merge, which demonstrates how the sub-set of interest is derived. The sub-set of interest is the set of Patient IDs for which at least one Date of Admission in the second summary was less than or equal to 30 days from at least one Date of Service in the first summary.

| | | | Date | |
|---|---|---|---|---|
| Patient ID | Date of Service | Date of Admission | Difference | <= 30? |
| 1000001 | Jan. 5, 2012 | Jan. 23, 2012 | 18 | Yes |
| 1000002 | May 7, 2011 | Mar. 5, 2012 | 303 | No |
| 1000003 | Apr. 15, 2010 | May 7, 2010 | 22 | Yes |
| 1000004 | | Aug. 15, 2011 | — | No |
| 1000005 | | Sep. 17, 2012 | — | No |
| 1000006 | Mar. 3, 2012 | | — | No |
| 1000007 | Oct. 5, 2012 | | — | No |

The following table is the binary mapping to be stored. Values in this table correspond to the “Yes” value of the binary mapping, and all other values not in this table implicitly correspond to the “No” value.

Patient ID
1000001
1000003

### Use of Binary Mapping on Another Data Source

Even though the set of values in the binary mapping is created on specific data sources, the use of this set could be on the same data sources or entirely different data sources. All it needs is to have the same Analysis Dimension available. There are two primary ways that the Event Based Analysis Dimension can be used in other queries:
Classification/Grouping (i.e. a “group by” type SQL action)
Filtering

Event Based Analysis Dimension Used for Classification:

The following are the required steps to use the Event Based Analysis Dimension for Classification:
1. Query 1: Primary Query including the Event Based Analysis Dimension (replace the Event Based Analysis Dimension by the Analysis Dimension to be used in “group by”)
2. Query 2: Aggregate again rolling up the distinct values of the Analysis Dimension to the corresponding binary value “Yes” or “No”, based on the presence of the value of the Analysis Dimension in the binary mapping.

An example may be to compare the total number of Professional services for the Patients who were admitted to In-Patient facility within 30 days of Outpatient visit vs. those who were not.

Data Source: Professional services

Classification Dimension (the Event Based Analysis Dimension): Patients with IP admits soon after OP visit

Measure: Number of Services

The following table shows the results of the query on the Professional Services, with Event Based Analysis Dimension replaced by the Analysis Dimension (Patient ID)

| Patient ID | Number of Services |
|---|---|
| 1000001 | 12 |
| 1000002 | 3 |
| 1000003 | 10 |
| 1000004 | 6 |
| 1000005 | 1 |
| 1000006 | 3 |
| 1000007 | 2 |

The following table shows the Patient ID values next to the values of “Yes” or “No” based on the Binary Mapping of the Event Based Analysis Dimension:

| | Patients with IP | |
|---|---|---|
| | admits soon | Number of |
| Patient ID | after OP visit | Services |
| 1000001 | Yes | 12 |
| 1000002 | No | 3 |
| 1000003 | Yes | 10 |
| 1000004 | No | 6 |
| 1000005 | No | 1 |
| 1000006 | No | 3 |
| 1000007 | No | 2 |

The following table shows the results aggregated to the Virtual Dimension “Patients with IP admits soon after OP visit”:

| Patients with IP | |
|---|---|
| admits soon | |
| after OP visit | Number of Services |
| Yes | 22 = 12 + 10 |
| No | 15 = 3 + 6 + 1 + 3 + 2 |

In some cases it is possible to perform these queries in one step (by using a clustering/grouping technique as part of the original query that is run). For example, by using a “dimension table” or in the SAS programming language this can be done by the use of a SAS Format.

Event Based Analysis Dimension Used for Filtering:

The filter on the Event Based Analysis Dimension is translated into a filter on the Analysis Dimension that the Event Based Analysis Dimension is based on, then the query runs as normal.

Query Request: filters (including one on the Event Based Analysis Dimension)+classifications+measures
1. Replace the Event Based Analysis Dimension filter with a new filter that uses the Analysis Dimension that it depends on, where these will resolve to the same rows.
2. Run the Query

Filter operators honoured and how filter translated:
=, IN
NOT logic

Values of the Event Based Analysis Dimension in the filter, which can be either “Yes” or “No” are replaced with the corresponding Analysis Dimension Values from the binary mapping. If the original filter is using the value of “No”, then the filter operator has to be negated.

Filtering can also be performed by keeping the binary mapping data in a temporary table and using a join with the query data source.

Metadata to Enable Analysis Dimension to be Linked Between Different Data Sources:

Given that the binary mapping can be created using different data sources and used on a yet another different data source it is important to ensure that the Analysis Dimension represents the same entity between different data sources. As these can be different data sources the column/variable that is used for the Analysis Dimension will be different and it may even have a different column/variable name in the different data sources. A mechanism is needed to ensure that metadata is defined to link different Dimensions that are registered within the metadata to enable the processing to know which data sources an Event Based Analysis Dimension can be used with.

The Preferred Approaches to Handle this Dimension Linking are:
To have a matrix of the Dimension definitions and all the data sources that use it. Thereby there is a single Dimension with one set of attributes even though it is available from different data sources.
To have a global Dimension definition that is stored independently from any data source, and then any dimension can link to this global Dimension definition to use its attributes and also for the purposes of this Event Based Analysis to know that all Dimensions that are linked to this global Dimension can be considered to represent the same entity.

Data Source Agnostic Querying:

Any additional functionality/features that require querying of the data is preferably implemented in a single/standard way by setting up appropriate metadata for the query, and then the query is performed by the corresponding query engine, which is unaware of the additional features. This allows the application to support any number of query engines, and add any number of additional features without having to implement each feature within each query engine.

Every query goes via a standard query interface layer which then delegates responsibility to the appropriate query engines that are supported.

Above this query tier, all metadata about queries to perform and what analyses the user wants to produce are in a standard form that do not have any dependencies with the underlying data sources—i.e. they are stored in a manner that is data source agnostic.

Additional Analytic Capability: Specify Filters as Part of Event Based Analysis Dimension

By specifying different Detail Level Filters for different data sources of the Event Based Analysis, the user is able to define each “event” and also limit the values of the Analysis Dimension that are used to create the binary mapping. For example, limiting the summary only to a particular time period or region, as well as specifying the filters that define the actual event.

By specifying Post-Aggregation Filters (the ones based on the final totals of any Measure), the user is potentially able to eliminate or isolate outliers, for example selecting only Top 10 values or Bottom 10, and be able to use different set of filters for each data source used in the Event Based Analysis.

FIG. 4 shows a preferred form process 400 that uses detail level filters. A first query is performed 405 on a first data source. Process 400 is similar to process 300 described above. A detail level filter is optionally applied 410 as part of the first query 405 to the first data source.

The first set of records obtained 415 based on the first event also depends on the detail level filter applied to the first data source.

A second query is performed 420 on a second data source. Once again a detail level filter is optionally applied 425 as part of the second query 420 to the second data source. The second set of records obtained 430 are based on both the second event and the detail level filter 425.

The filtered first set of records and the filtered second set of records are combined 435 and a binary mapping 440 generated as described above.

The following provides an example:

Name: Patients with IP admits in the last year soon after Emergency Room (ER) Visit

First Event:
Data Source: Out-Patient Claims Data
Analysis Dimension Patient ID
Time Dimension: Date of Service
Detail Filter Type of Service=“Emergency Room”

Second Event:
Data Source: In-Patient Claims Data
Time Dimension Date of Admission
Detail Filter: Year of Admission=“2012”

Time Interval: 30

Operator: “<=”

The following table shows the result of the query to the Analysis Dimension and Time Dimension for the first event (Out-patient visit) with filter Type of Service=“Emergency Room” applied:

| Patient ID | Date of Service |
|---|---|
| 1000001 | Jan. 5, 2012 |
| 1000002 | May 7, 2011 |
| 1000007 | Oct. 5, 2010 |

The following table shows the result of the query to the Analysis Dimension and Time Dimension for the second event (In-patient admission) with filter Year of Admission=“2012” applied:

| Patient ID | Date of Admission |
|---|---|
| 1000001 | Jan. 23, 2012 |
| 1000005 | Sep. 17, 2012 |

The following table shows the result of the merge, which demonstrates how the sub-set of interest is derived. The sub-set of interest is the set of Patient IDs for which at least one Date of Admission in the second summary was less than or equal to 30 days from at least one Date of Service in the first summary.

| | | | Date | |
|---|---|---|---|---|
| Patient ID | Date of Service | Date of Admission | Difference | <= 30? |
| 1000001 | Jan. 5, 2012 | Jan. 23, 2012 | 18 | Yes |
| 1000002 | May 7, 2011 | | — | No |
| 1000005 | | Sep. 17, 2012 | — | No |
| 1000007 | Oct. 5, 2012 | | — | No |

The following table shows the result of the merge, which comprises the sub-set of interest and is the binary mapping to be stored. Values in this table correspond to the “Yes” value of the binary mapping, and all other values not in this table implicitly correspond to the “No” value.

Patient ID
1000001

FIG. 5 shows a preferred form process 500 that uses post-aggregation filters. The process 500 is similar to process 300 and process 400 described above. As shown in FIG. 5 a first query is performed 505 on a first data source. A first set of records is obtained 510 based on the first event. Optionally, if there are any post-aggregation filters for the first data source, an aggregation of the first set of records by Analysis Dimension 515 is performed, so that post-aggregation filters can be applied. A post-aggregation filter is applied 520 to the results of this aggregation.

A second query is performed 525 on a second data source. A second set of records is obtained 530 based on a second event. Optionally, if there are any post-aggregation filters for the second data source, an aggregation of the second set of records by Analysis Dimension 535 is performed, so that post-aggregation filters can be applied. A post-aggregation filter is applied 540 to the results of this aggregation.

At 545 the query results of the first query, the second query and if present, one or both results from applying the post-aggregation filters are combined. A binary mapping is then generated 550 as described above.

The Following Provides an Example:

Name: High Cost Patients with IP admits soon after Emergency Room (ER) Visit

First Event:
Data Source: Out-Patient Claims Data
Analysis Dimension Patient ID
Time Dimension Date of Service

Second Event:
Data Source: In-Patient Claims Data
Time Dimension Date of Admission
Post-Aggregation Filter: Total Cost >$30,000

Time Interval: 30

Operator: “<=”

The following table shows the result of the query to the Analysis Dimension and Time Dimension for the first event (Out-patient visit):

| Patient ID | Date of Service |
|---|---|
| 1000001 | Jan. 5, 2012 |
| 1000002 | May 7, 2011 |
| 1000003 | Oct. 5, 2010 |

The following table shows the result of the query to the Analysis Dimension and Time Dimension for the second event (In-patient admission) with the Total Cost Measure, required for application of the Post Aggregation filter:

| Patient ID | Date of Admission | Total Cost |
|---|---|---|
| 1000001 | Jan. 23, 2012 | $20,000 |
| 1000002 | Sep. 17, 2012 | $25,000 |
| 1000003 | Oct. 15, 2010 | $15,000 |
| 1000003 | Nov. 15, 2010 | $16,000 |
| 1000004 | Jan. 7, 2012 | $50,000 |

The following table shows the result of the aggregation to the Analysis Dimension of the previous query results with the Total Cost Measure:

| Patient ID | Total Cost |
|---|---|
| 1000001 | $20,000 |
| 1000002 | $25,000 |
| 1000003 | $31,000 = $15,000 + $16,000 |
| 1000004 | $50,000 |

The following table shows the result of applying Post-Aggregation Filter (Total Cost >$30,000) to the above summary:

| Patient ID | Total Cost |
|---|---|
| 1000003 | $31,000 |
| 1000004 | $50,000 |

The following table shows the result of the merge, which demonstrates how the sub-set of interest is derived. The sub-set of interest is the set of Patient IDs for which at least one Date of Admission in the second summary was less than or equal to 30 days from at least one Date of Service in the first summary and the Patient ID is part of the set created by applying Post-Aggregation filter.

| | | | | Included | |
|---|---|---|---|---|---|
| | | | | in Post- | |
| | | | Date | Aggregation | |
| Patient | Date of | Date of | Differ- | filter | |
| ID | Service | Admission | ence | results? | <= 30? |
| 1000001 | Jan. 5, 2012 | Jan. 23, 2012 | 18 | No | Yes |
| 1000002 | May 7, 2011 | Sep. 17, 2012 | 499 | No | No |
| 1000003 | Oct. 5, 2010 | Oct. 15, 2010 | 10 | Yes | Yes |
| 1000003 | Oct. 5, 2010 | Nov. 15, 2010 | 41 | Yes | No |
| 1000004 | | Jan. 7, 2012 | — | Yes | No |

The following table shows the result of the merge, which comprises the sub-set of interest and is the binary mapping to be stored. Values in this table correspond to the “Yes” value of the binary mapping, and all other values not in this table implicitly correspond to the “No” value.

Patient ID
1000003

Event Based Analysis Dimensions can be created with no filters, or any combination of Detail Level Filters or Post-Aggregation Filters.

Caching:

Caching is an important or useful technique as it avoids duplicating and repeating more work than required. It also facilitates efficiency as it is not necessary to store the entire binary mapping as part of the cache index.

When the Event Based Analysis Dimension is used in another data source and it is used in the query for classification or filtering then it is necessary to store a definition of all the attributes that it depends on so that it can be determined when to re-query the binary mapping, so there is an index for this Event Based Analysis Dimension based on:
Data Source 1 ID
Datetime Stamp of when the Data Source 1 was last modified (this is key to prevent needing to re-create the Mapping Relationship unless something has changed from a data perspective)
All “query relevant” Attributes used by dimensions and measures:
   Analysis Dimension
   Time Dimension 1
   Any Detail Level Filters or Post-Aggregation Filters and their dependent metadata for Data Source 1
Data Source 2 ID
Date-time Stamp of when the Data Source 2 was last modified
All “query relevant” Attributes used by dimensions and measures:
   Time Dimension 2
   Any Detail Level Filters or Post-Aggregation Filters and their dependent metadata for Data Source 2
Time Interval
Operator

It is Preferable to Enable Stored/Persisted Metadata to Define Event Based Analysis Dimension.

The Metadata for Event Based Analysis Dimension is stored independently from the data source or the Report. Any Reports that use the Event Based Analysis Dimension store the reference to it, but not the actual Event Based Analysis Dimension definition or the binary mapping. This way the definition can be modified, and Reports that use it and reference it, can use the most current definition whenever they run. It also allows for storage of the Metadata at different levels, allowing “global” level that is accessible to all the users, “user group” level, that can be created by a member of a user group and be available to all others members of the same group, as well as “personal” where the definition can only be created and used by the same user who created it.

This also allows for capability to duplicate an existing definition, so it can be modified slightly and saved as a separate Event Based Analysis Dimension, possibly with a different level of access.

The Event Based Analysis Dimensions can be stored independently from any data source within a hierarchical folder structure and these can be stored at the following different levels:
Global level
User Group level
Personal level

Security and Restricted Access:

Not having access to either of the data sources or Analysis Dimension will prevent access to Event Based Analysis Dimension if required.

If an end user does not have access to the data sources, it is possible to specify that the user would also not be able to access any Event Based Analysis Dimensions that are based on that data source. But, it might be necessary to allow access to the Event Based Analysis Dimension even if the data source is not accessible for direct querying, since in that case the data source would only be used to create the binary mapping for the Event Based Analysis Dimension.

If the user does not have access to the Analysis Dimension of the Event Based Analysis Dimension, it is possible to specify that the user would also not be able to access the Event Based Analysis Dimension. In order to apply the Event Based Analysis Dimension to any data source, that data source must have the Analysis Dimension in common, but it may or may not be accessible to the user to use directly.

Security settings preferably allow the administrator to configure access to the Event Based Analysis Dimension if the data source and/or the Analysis Dimension are restricted from the user.

During Event Based Analysis Dimension creation and usage in a Report, security is checked and appropriate messages are generated for the user if the Event Based Analysis Dimension is not accessible.

Example User Interface to Create, Maintain and Use Event Based Analysis Dimensions

First the Event Based Analysis Dimension needs to be defined and saved. This can be done via pull-down menu: Create A New Segmentation Dimension->Analysis Group . . . .

FIG. 6 shows the preferred way of starting the process for creating an Event Based Analysis Dimension.

FIG. 7 shows an example of creating a new Event Based Analysis Dimension. When creating an Event Based Analysis Dimension the user has to specify the following attributes:
Analysis Group Name
Data Source 1 (or Earlier Event)
Analysis Dimension
Time Dimension for Data Source 1
Detail Filters for Data Source 1 (optional)
Aggregate Filters for Data Source 1 (optional)
Operator for Time comparison
Time Interval to be used in comparison
Data Source 2 (or Later Event)
Time Dimension for Data Source 2
Detail Filters for Data Source 2 (optional)
Aggregate Filters for Data Source 2 (optional)

FIG. 8 shows an example of saving a newly created Event Based Analysis Dimension to the menu of Segmentation Dimensions. The figure shows how Event Based Analysis Dimension can be saved at different levels: as a Global Dimension available to all users, as a Personal Dimension available only to the user who created it, or as a Group Shared Dimension, available to all members of a particular User Group. Saved Dimensions could be organized into folders within a Menu structure, and during saving of the Event Based Analysis Dimension various menu specific operations could be performed: creating a new folder, moving a menu item to another folder, renaming or deleting a menu item.

Once Event Based Analysis Dimensions exist, they can be used within other Reports by selecting which Event Based Analysis Dimension is desired and then “Applying” it to the Report.

As shown in FIG. 9, once the definition is saved, the same or a different user can “Apply” the Event Based Analysis Dimension to a Report. The preferred way of doing this is by selecting “Apply Segmentation Dimensions . . . ” from the pull-down menu.

Then an end user will select the required Event Based Analysis Dimension from the menu, choosing an option to apply it as a filter or as a classification dimension, and clicking “Apply” button is shown in FIG. 10.

Preferably, only Event Based Analysis Dimensions applicable to the current Report will be visible in the menu, meaning:
they are based on an Analysis Dimension which exists in the data source of the current Report
they are based on a data source that is either not restricted from the end user, or the data source is configured not to restrict Segmentation Dimensions based on it.

As part of the application process, the following steps are preferably performed automatically:
The Data Source 1 specified in the definition of the Event Based Analysis Dimension is summarized by the Analysis Dimension and the Time Dimension 1 with the filters applied (if any).
The Data Source 2 specified in the definition of the Event Based Analysis Dimension is summarized by the Analysis Dimension and Time Dimension 2 with the filters applied (if any).
Merge the two query results by Analysis Dimension keeping only the distinct values of Analysis Dimension where its values exist in both query results and where for that value of the Analysis Dimension at least one difference between Time Dimension 2 and Time Dimension 1 presented in common time units is within the Time Interval using the Operator specified as part of the Event Based Analysis Dimension, implicitly mapping these values to “Yes”. All other values of the Analysis Dimension are implicitly considered to correspond to the value of “No”.
The new Virtual Dimension is created and added to the current Report as a classification Dimension, as shown in FIG. 11.

Once the Event Based Analysis Dimension is created as a Virtual Dimension, it can be used just like any other dimension on the Report: for classification, in filters, charts, etc.

When the Report is saved, the Event Based Analysis Dimension used by the Report is saved with it, but every time the Report is used, the cache will be checked to see if these query results have already been created, and if they haven't or if any of the data sources or attributes that it depends on have changed then the process of mapping of the Analysis Dimension values to the values of “Yes” or “No” is repeated using the current data and the current definition of the Event Based Analysis Dimension (as it could have been modified since first created). So, the process of “applying” an Event Based Analysis Dimension is repeated. Therefore, if neither the definition of the Event Based Analysis Dimension, nor any of the underlying data sources or filter metadata attributes have changed, nor the underlying data sources have been updated, then preferably the cache is going to be used to produce the Report using the Event Based Analysis Dimension, which will greatly improve its performance.

As mentioned above, the definition of the Event Based Analysis Dimension can be modified. This is done via Viewpoint->Manage Segmentation Dimensions, as shown in FIG. 12.

The management screen presents the end user on user device(s) 130 with the menu structure containing Event Based Analysis Dimensions (and any other types of Segmentation Dimensions defined).

As shown in FIG. 13, the end user can create new folders, rename, delete or move any of the objects on the menu, edit an existing Event Based Analysis Dimension or duplicate one.

While editing or duplicating the Event Based Analysis Dimension, the end user can modify any aspect of it, including converting it into a simple Analysis Group Dimension that is not based on events and time difference between them, as shown in FIG. 14.

The techniques described above have the potential to provide one or more of the following benefits:
Provides powerful analysis feature by allowing 2-step processing of the data automatically
Event Based Analysis Dimensions created on the fly by the end users using a simple and intuitive interface
Use of this functionality does not require any changes to the underlying data source
Use of this functionality does not require Futrix administrator involvement
Completely dynamic and automatic, providing accurate results when the data changes
Optimized for performance via the use of cache and storage of large number of values in the table/datasets vs. in memory
Allows for additional filtering
Event Based Analysis Dimension metadata can be stored at different levels: Global, User Group or Personal
Event Based Analysis Dimensions are secure and use powerful security that controls who can create Global Event Based Analysis Dimensions, and which Event Based Analysis Dimensions are available to what end users based on the restrictions imposed on the data source or the Analysis Dimension, while still allowing flexibility of using the Event Based Analysis Dimension even when the data source and/or the Analysis Dimension are restricted, if so desired.

What is claimed:

1. A method of performing event based analysis comprising:
performing a first query on a first data source to obtain a first set of records based on a first event, the first set of records including an analysis dimension variable and a first time dimension variable;
performing a second query on a second data source, the second query independent from the first query, to obtain a second set of records based on a second event, the second set of records including the analysis dimension variable and a second time dimension variable;
generating a result set by combining the first set of records and the second set of records to find an intersection of the two sets based at least partly on the first time dimension variable and the second time dimension variable; and
generating a binary mapping from the result set to establish a distinct set of values of the analysis dimension variable that match the intersection of the two sets.

2. The method of claim 1 wherein performing the first query on the first data source includes applying a detail level filter.

3. The method of claim 2 wherein the detail level filter is based at least partly on a stored binary mapping.

4. The method of claim 1 wherein performing the second query on the second data source includes applying a detail level filter.

5. The method of claim 4 wherein the detail level filter is based at least partly on a stored binary mapping.

6. The method of claim 1 further comprising performing an aggregation of the first set of records.

7. The method of claim 6 further comprising applying a post-aggregation filter to the first set of records.

8. The method of claim 7 wherein the post-aggregation filter is based at least partly on a stored binary mapping.

9. The method of claim 1 further comprising performing an aggregation of the second set of records.

10. The method of claim 9 further comprising applying a post-aggregation filter to the second set of records.

11. The method of claim 10 wherein the post-aggregation filter is based at least partly on a stored binary mapping.

12. The method of claim 1 further comprising receiving a time interval, the values of the first time dimension variable and the second time dimension variable in the intersection of the two sets lying within the time interval.

13. The method of claim 1 further comprising receiving a time interval, the values of the first time dimension variable and the second time dimension variable in the intersection of the two sets lying outside the time interval.

14. The method of claim 1 further comprising receiving a time interval, the values of the first time dimension variable and the second time dimension variable in the intersection of the two sets equal to the time interval.

15. The method of claim 1 wherein the analysis dimension variable uniquely identifies the first set of records.

16. The method of claim 1 wherein the analysis dimension variable uniquely identifies the second set of records.

17. The method of claim 1 wherein the first data source is independent of the second data source.

18. The method of claim 1 wherein the first data source is related to the second data source.

19. The method of claim 1 further comprising performing a third query on a third data source based at least partly on the binary mapping.

20. The method of claim 1 further comprising displaying a representation of the binary mapping on a user device.

21. A system for event based analysis, comprising:
at least one processor programmed to:
perform a first query on a first data source to obtain a first set of records based on a first event, the first set of records including an analysis dimension variable and a first time dimension variable;
perform a second query on a second data source, the second query independent from the first query, to obtain a second set of records based on a second event, the second set of records including the analysis dimension variable and a second time dimension variable;
generate a result set by combining the first set of records and the second set of records to find an intersection of the two sets based at least partly on the first time dimension variable and the second time dimension variable; and
generate a binary mapping from the result set to establish a distinct set of values of the analysis dimension variable that match the intersection of the two sets.

22. The system of claim 21 wherein performing the first query on the first data source includes applying a detail level filter.

23. The system of claim 22 wherein the detail level filter is based at least partly on a stored binary mapping.

24. The system of claim 21 wherein performing the second query on the second data source includes applying a detail level filter.

25. The system of claim 24 wherein the detail level filter is based at least partly on a stored binary mapping.

26. The system of claim 21 wherein the at least one processor is further programmed to perform an aggregation of the first set of records.

27. The system of claim 26 wherein the at least one processor is further programmed to apply a post-aggregation filter to the first set of records.

28. The system of claim 27 wherein the post-aggregation filter is based at least partly on a stored binary mapping.

29. The system of claim 21 wherein the at least one processor is further programmed to perform an aggregation of the second set of records.

30. The system of claim 29 wherein the at least one processor is further programmed to apply a post-aggregation filter to the second set of records.

31. The system of claim 30 wherein the post-aggregation filter is based at least partly on a stored binary mapping.

32. The system of claim 21 wherein the at least one processor is further programmed to receive a time interval, the values of the first time dimension variable and the second time dimension variable in the intersection of the two sets lying within the time interval.

33. The system of claim 21 wherein the at least one processor is further programmed to receive a time interval, the values of the first time dimension variable and the second time dimension variable in the intersection of the two sets lying outside the time interval.

34. The system of claim 21 wherein the at least one processor is further programmed to receive a time interval, the values of the first time dimension variable and the second time dimension variable in the intersection of the two sets equal to the time interval.

35. The system of claim 21 wherein the analysis dimension variable uniquely identifies the first set of records.

36. The system of claim 21 wherein the analysis dimension variable uniquely identifies the second set of records.

37. The system of claim 21 wherein the first data source is independent of the second data source.

38. The system of claim 21 wherein the first data source is related to the second data source.

39. The system of claim 21 wherein the at least one processor is further programmed to perform a third query on a third data source based at least partly on the binary mapping.

40. The system of claim 21 further configured to display a representation of the binary mapping on a user device.

41. A system for event based analysis comprising:
a user interface layer configured to receive a first query and a second query;
a data management layer configured to receive a direction from the user interface layer based at least partly on the first query and the second query;
a query engine configured to perform the first query on a first data source and to perform a second query on a second data source; and
a data storage component configured to store:
a first set of records obtained from performing the first query on the first data source, the first set of records including an analysis dimension variable and a first time dimension variable;
a second set of records obtained from performing the second query on the second data source, the second set of records including the analysis dimension variable and a second time dimension variable;
a result set obtained by the data management layer combining the first set of records and the second set of records to find an intersection of the two sets based at least partly on the first time dimension variable and the second time dimension variable; and
a binary mapping generated by the data management layer at least partly from the result set.

42. A computer-readable medium having stored thereon processor-executable instructions that when executed by a processor cause the processor to perform a method of performing event based analysis, the method comprising:
performing a first query on a first data source to obtain a first set of records based on a first event, the first set of records including an analysis dimension variable and a first time dimension variable;
performing a second query on a second data source, the second query independent from the first query, to obtain a second set of records based on a second event, the second set of records including the analysis dimension variable and a second time dimension variable;
generating a result set by combining the first set of records and the second set of records to find an intersection of the two sets based at least partly on the first time dimension variable and the second time dimension variable; and
generating a binary mapping from the result set to establish a distinct set of values of the analysis dimension variable that match the intersection of the two sets.

43. The computer readable medium of claim 42 wherein performing the first query on the first data source includes applying a detail level filter.

44. The computer readable medium of claim 43 wherein the detail level filter is based at least partly on a stored binary mapping.

45. The computer readable medium of claim 42 wherein performing the second query on the second data source includes applying a detail level filter.

46. The computer readable medium of claim 45 wherein the detail level filter is based at least partly on a stored binary mapping.

47. The computer readable medium of claim 42 wherein the method further comprises performing an aggregation of the first set of records.

48. The computer readable medium of claim 47 wherein the method further comprises applying a post-aggregation filter to the first set of records.

49. The computer readable medium of claim 48 wherein the post-aggregation filter is based at least partly on a stored binary mapping.

50. The computer readable medium of claim 42 wherein the method further comprises performing an aggregation of the second set of records.

51. The computer readable medium of claim 50 wherein the method further comprises applying a post-aggregation filter to the second set of records.

52. The computer readable medium of claim 51 wherein the post-aggregation filter is based at least partly on a stored binary mapping.

53. The computer-readable medium of claim 42 wherein the method further comprises receiving a time interval, the values of the first time dimension variable and the second time dimension variable in the intersection of the two sets lying within the time interval.

54. The computer-readable medium of claim 42 wherein the method further comprises receiving a time interval, the values of the first time dimension variable and the second time dimension variable in the intersection of the two sets lying outside the time interval.

55. The computer-readable medium of claim 42 wherein the method further comprises receiving a time interval, the values of the first time dimension variable and the second time dimension variable in the intersection of the two sets equal to the time interval.

56. The computer-readable medium of claim 42 wherein the analysis dimension variable uniquely identifies the first set of records.

57. The computer-readable medium of claim 42 wherein the analysis dimension variable uniquely identifies the second set of records.

58. The computer-readable medium of claim 42 wherein the first data source is independent of the second data source.

59. The computer-readable medium of claim 42 wherein the first data source is related to the second data source.

60. The computer-readable medium of claim 42 wherein the method further comprises performing a third query on a third data source based at least partly on the binary mapping.

61. The computer-readable medium of claim 42 wherein the method further comprises displaying a representation of the binary mapping on a user device.
